(19) United States
(12) Patent Application Publication
(10) Pub. No.: US 2013/0265323 A1
(43) Pub. Date: Oct. 10, 2013

(54) UNEVENNESS CORRECTION APPARATUS AND METHOD FOR CONTROLLING SAME

(71) Applicant: CANON KABUSHIKI KAISHA, Tokyo (JP)

(72) Inventors: Kenichi Morikawa, Kawasaki-shi (JP); Takehito Hiyoshi, Hiratsuka-shi (JP)

(73) Assignee: CANON KABUSHIKI KAISHA, Tokyo (JP)

(21) Appl. No.: 13/837,433

(22) Filed: Mar. 15, 2013

(30) Foreign Application Priority Data
Apr. 6, 2012 (JP) 2012-087377
Feb. 20, 2013 (JP) 2013-031096

(51) Int. Cl. G09G 5/06

(52) U.S. Cl. CPC G09G 5/06
USPC 345/601

(57) ABSTRACT

An unevenness correction apparatus according to the present invention comprises: a storage unit that stores correction tables, which are used for correction processing to correct unevenness on a screen of a display apparatus, for a plurality of division areas constituting an area of the screen respectively; and a correction unit that performs the correction processing on image data to be displayed on the display apparatus, using at least one correction table which includes a correction table for a division area including a target position of the correction processing, out of the correction tables for respective division areas stored in the storage unit, wherein a relatively large division area is set in a center portion of the screen, and a relatively small division area is set in an edge portion of the screen.

### BACKGROUND OF THE INVENTION

1. Field of the Invention

The present invention relates to an unevenness correction apparatus and a method for controlling the unevenness correction apparatus.

2. Description of the Related Art

It is known that in the case of a direct view display, color unevenness and brightness unevenness are generated, since displayed color (color gamut) and brightness change depending on a position within the screen. Such color unevenness and brightness unevenness are generated due to a structure of light sources of a display apparatus, for example. In concrete terms, the color unevenness and the brightness unevenness are generated because the reflection characteristics of light, coming from a light emitting diode (LED) backlight on the rear face of the liquid crystal panel, differ at the edge portions and at the center portion of the screen. If the chromaticity points of primary colors are accurately set in a state where the color unevenness is generated, a difference is generated particularly around a skin color, which is an intermediate color, the differences of which are easily recognized by human eyes. Furthermore, in the case of the above mentioned display apparatus, additive color mixing cannot be used, and R sub-pixels, G sub-pixels and B sub-pixels are correlated. Therefore the color unevenness and the brightness unevenness cannot be corrected by simple offset gain processing and correction processing using a one-dimensional look up table (1DLUT), which is independent for each sub-pixel.

A technique to correct the color unevenness is disclosed in Japanese Patent Application Laid-Open No. 2010-118923, for example. In this technique disclosed in Japanese Patent Application Laid-Open No. 2010-118923, a plurality of color conversion tables corresponding to a plurality of positions where change of color unevenness is characteristic is used. Then based on the distance between a target pixel and the positions where color unevenness is characteristic, outputs of the plurality of color conversion tables are interpolated or combined, whereby the color conversion result of the target pixel is generated.

However in the case of the above mentioned conventional technique, a three-dimensional look up table (3DLUT) is assigned to a location where color unevenness changes, hence the following problem is generated depending on how the 3DLUT is assigned. For example, if the number of types (patterns) of a 3DLUT is decreased, accuracy of the correction processing (color unevenness correction processing) drops. If the number of types of 3DLUT is increased, on the other hand, accuracy of the color unevenness correction processing increases, but enormous hardware resources (e.g. memory) are required.

### SUMMARY OF THE INVENTION

The present invention provides a technique to accurately perform correction processing for correcting unevenness on a screen using a small amount of hardware resources.

An unevenness correction apparatus according to the present invention comprises:

a storage unit that stores correction tables, which are used for correction processing to correct unevenness on a screen of a display apparatus, for a plurality of division areas constituting an area of the screen respectively; and

a correction unit that performs the correction processing on image data to be displayed on the display apparatus, using at least one correction table which includes a correction table for a division area including a target position of the correction processing, out of the correction tables for respective division areas stored in the storage unit, wherein

a relatively large division area is set in a center portion of the screen, and a relatively small division area is set in an edge portion of the screen.

A method for controlling an unevenness correction apparatus according to the present invention is a method for controlling an unevenness correction apparatus that has a storage unit which stores, in advance, correction tables to be used for correction processing to correct unevenness on the screen, for a plurality of division areas constituting an area of a screen of a display apparatus respectively.

The method comprises:

a step of inputting image data which is displayed on the display apparatus; and

a correction step of performing the correction processing on the image data, using at least one correction table which includes a correction table for a division area including a target position of the correction processing, out of the correction tables for respective division areas stored in the storage unit, wherein

a relatively large division area is set in a center portion of the screen, and a relatively small division area is set in an edge portion of the screen.

According to the present invention, a correction processing for correcting unevenness on a screen can be accurately performed using a small amount of hardware resources.

Further features of the present invention will become apparent from the following description of exemplary embodiments with reference to the attached drawings.

### BRIEF DESCRIPTION OF THE DRAWINGS

FIG. 1 is an example of a flow to create a 3DLUT and a 3DLUT assignment table;

FIG. 2 shows an example of sub-division areas;

FIG. 3 shows an example of grouping sub-division areas;

FIG. 4 shows an example of a division area dividing result;

FIG. 5 shows an example of a functional configuration of an unevenness correction apparatus according to this embodiment;

FIG. 6 shows an example of lattice points of a 3DLUT;

FIG. 7 shows an example of a 3DLUT;

FIG. 8 shows an example of a method for detecting a target area and peripheral areas;

FIG. 9 shows an example of a method for assigning an area number;

FIG. 10 shows an example of a 3DLUT assignment table;

FIG. 11A and FIG. 11B show examples of a blend ratio table;

FIG. 12 shows an example of a division area dividing result;

FIG. 13A and FIG. 13B show examples of a division area dividing result;

FIG. 14A and FIG. 14B show examples of a division area dividing result;

FIG. 15A and FIG. 15B show examples of a division area dividing result;

FIG. 16A and FIG. 16B show examples of a division area dividing result;

FIG. 17A to FIG. 17D show examples of a division area dividing result;

FIG. 18A and FIG. 18B show examples of a division area dividing result; and

FIG. 19A and FIG. 19B show examples of a division area dividing result.

### DESCRIPTION OF THE EMBODIMENTS

An unevenness correction apparatus and a method for controlling the unevenness correction apparatus according to an embodiment of the present invention will now be described with reference to the drawings. The unevenness correction apparatus according to the following embodiment performs correction processing (correction processing to correct unevenness on the screen of the display apparatus: unevenness correction processing) on image data displayed on the display apparatus, using a correction table stored in a storage unit. In the following embodiment, it is assumed that a plurality of 3DLUTs are provided as the correction tables, and a 3DLUT to be used is selected using a 3DLUT assignment table (details will be described later). The unevenness correction apparatus of the present invention can be applied to a liquid crystal display apparatus having a backlight constituted by red LEDs, green LEDs and blue LEDs, or a liquid crystal display apparatus having a backlight constituted by only white LEDs. Even if a backlight is constituted of only white LEDs, it is preferable to perform unevenness correction processing, since the edges of the screen sometimes become a white color light tinted with a specific tinge.

### Embodiment 1

In Embodiment 1, an example especially suitable for a liquid crystal display apparatus having a direct view type backlight (many light sources, such as LEDs, are arranged on a plane) or a liquid crystal display apparatus having a tandem type backlight (a plurality of wedge type light guiding plates are arranged in a matrix) will be described. However, the present invention can also be applied to an edge light type (also called a sidelight type or a light guiding plate type) backlight.

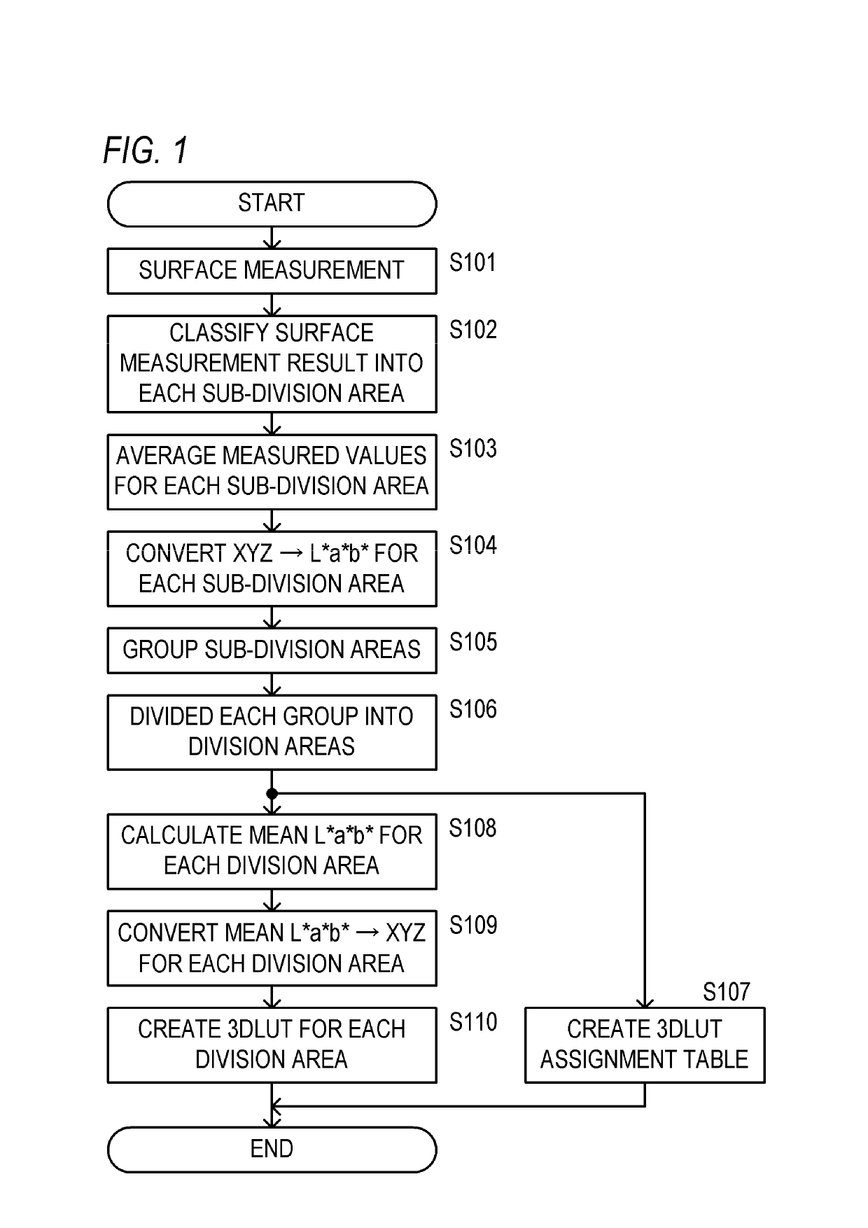

A flow of creating a 3DLUT and a 3DLUT assignment table will be described with reference to FIG. 1.

In step S101, color and brightness on the screen, when the image data is displayed on the display apparatus, are measured (surface measurement). Color and brightness on the screen is measured using a measuring instrument, such as a two-dimensional measuring instrument. In this step, color and brightness are measured at a plurality of positions (e.g. each pixel) on the screen respectively. In this embodiment, it is assumed that XYZ tristimulus values (X value, Y value, Z value) are acquired as measured values. For the two-dimensional measuring instrument, an imaging apparatus to acquire RGB values, such as a digital camera, may be used.

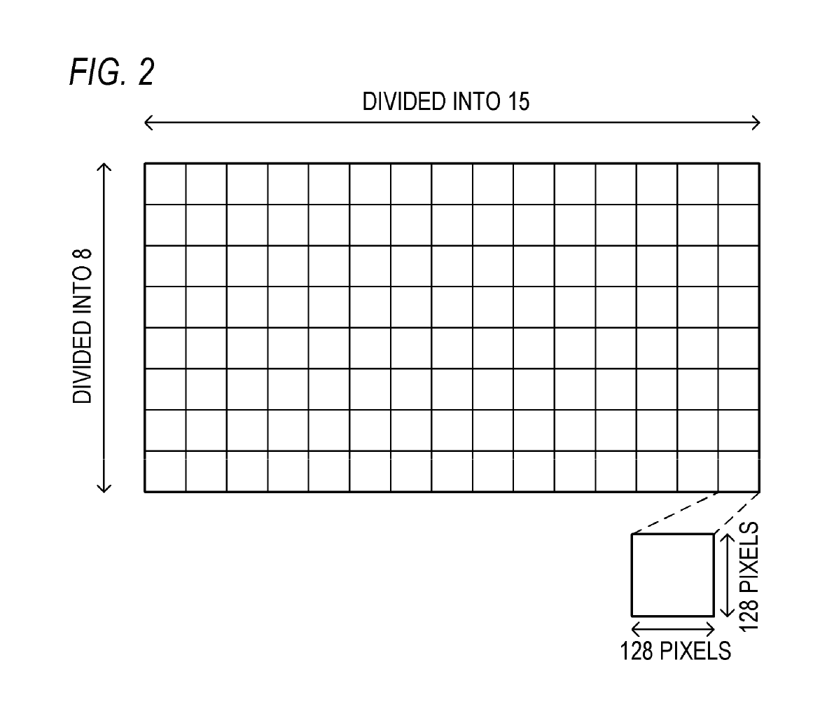

In step S102, the measured values acquired in step S101 are classified for each sub-division area. A sub-division area is an area acquired by dividing an area on a screen. FIG. 2 shows an example of sub-division areas. In the case of FIG. 2, an area on the screen is divided into 15 in the horizontal direction×8 in the vertical direction, totalling 120 sub-division areas. In the case of FIG. 2, one sub-division area is constituted by 128 pixels in the horizontal direction×128 pixels in the vertical direction. A sub-division area is not limited to this example. For example, the sizes of sub-division areas need not be uniform.

In step S103, for each sub-division area, a representative value of measured values acquired for positions within the sub-division area is calculated (e.g. a mean value, a maximum value, a minimum value, a mode). In this embodiment, it is assumed that a mean value is calculated as a representative value (average measured value).

In step S104, for each sub-division area, representative values calculated in step S103 (averaged XYZ tristimulus values) are converted into values of L*a*b* color system of CIE 1976 (L* value, a* value, b* value). For example, the XYZ tristimulus values are converted into L*a*b* color system values using the following conversion Expressions 1-1 to 1-3. In Expressions 1-1 to 1-3, Xn, Yn and Zn are constants.

$$\begin{matrix}[ E1 ] & \\ {L}^{*} = 116 {( \frac{Y}{Yn} )}^{\frac{1}{3}} - 16 & ( Expression 1 \text{-} 1 ) \\ {a}^{*} = 500 [ {( \frac{X}{Xn } )}^{\frac{1}{3}} - {( \frac{Y}{Yn} )}^{\frac{1}{3}} ] & ( Expression 1 \text{-} 2 ) \\ {b}^{*} = 200 [ {( \frac{Y}{Yn} )}^{\frac{1}{3}} - {( \frac{Z}{Zn} )}^{\frac{1}{3}} ] \\ where \\ \frac{Y}{Yn} > 0.008856 \\ \frac{X}{Xn} > 0.008856 \\ \frac{Z}{Zn} > 0.008856 & ( Expression 1 \text{-} 3 )\end{matrix}$$

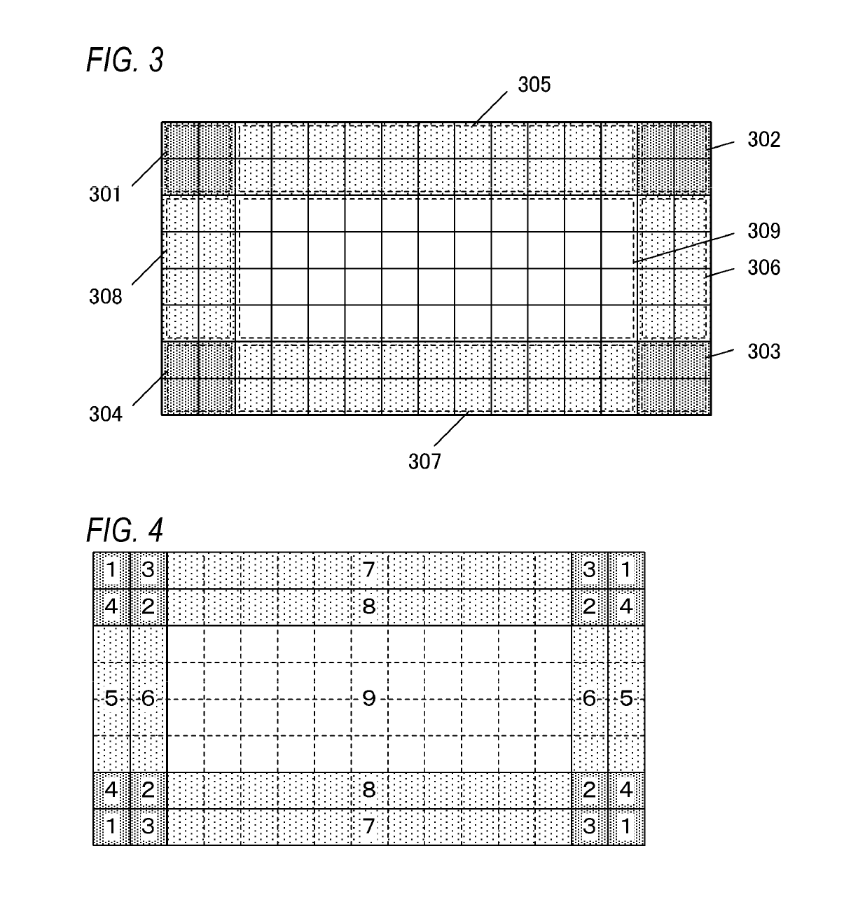

In step S105, the sub-division areas are grouped. In the display apparatus according to this embodiment, color unevenness is generated because of the difference of color gamut between the center portion and the edge portion of the screen, for example. In concrete terms, color unevenness and brightness unevenness are generated due to structural factors, that is, the reflection characteristic of the light from the LED backlight (characteristic of the reflection on the rear face of the liquid crystal panel) is different between the edge portion and the center portion of the screen. In order to correct such color unevenness and brightness unevenness, according to this embodiment, sub-division areas are classified into three groups: four corners (areas 301 to 304); upper, lower, left and right edge portions (areas 305 to 308); and a center portion (area 309) as shown in FIG. 3.

In step S106, each group is divided into division areas to which a 3DLUT is assigned respectively. Also, a pattern of a 3DLUT to be assigned to each division area is determined. In this embodiment, division areas are set so that the number of 3DLUTs (number of patterns) to be assigned is smaller than the maximum number of 3DLUTs that can be assigned. According to this embodiment, a relatively large division area is set in a center portion on the screen, and relatively small division areas are set in edge portions (four corner portions and upper, lower, left and right portions) of the screen. The sizes of the division areas are set so as to be smaller in the portions of the four corners of the screen (four corner portions) than the other edge portions (upper, lower, left and right edge portions). In concrete terms, the number of division areas is greater in the upper, lower, left and right edge portions (areas 305 to 308) than in the center portion (area 309), and is greater in the four corner portions (areas 301 to 304) than in the upper, lower, left and right edge portions (areas 305 to 308). In other words, more 3DLUTs are assigned to the upper, lower, left and right edge portions than the center portion, and to the four corner portions than the upper, lower, left and right edge portions.

The division areas can be acquired by dividing the screen area based on color unevenness and brightness consistency on the screen when one color (a single color or a mixed color) image data is displayed on the display apparatus. In concrete terms, the division areas can be set based on a result of classifying representative values (averaged XYZ tristimulus values) for each sub-division area using the K means clustering, for example.

FIG. 4 shows an example of the division area dividing result. In FIG. 4, numbers 1 to 9 are numbers indicating a 3DLUT pattern to be assigned (pattern number).

In the case of FIG. 4, each one of the four corner portions (each one of areas 301 to 304) is divided into four division areas (the same areas as sub-division areas). The center portion is not divided (the center portion is one division area). Each one of the upper, lower, left and right areas (each one of areas 305 to 308) is divided into two division areas.

In the case of FIG. 4, it is assumed that a same 3DLUT is assigned to the two division areas acquired by dividing the left edge portion 308 and to the two division areas acquired by dividing the right edge portion 306. However a 3DLUT assigned to the left edge portion 308 and a 3DLUT assigned to the right edge portion 306 may be different from each other depending on the state of color unevenness and brightness unevenness. The same is true for the four corner portions (areas 301 to 304) and upper and lower edge portions (areas 305 and 307).

In the case of FIG. 4, the number of 3DLUT patterns is 9, but the number of 3DLUT patterns may be greater and smaller than 9.

In step S107, a 3DLUT assignment table, which indicates a corresponding 3DLUT pattern for each sub-division area, is created based on the processing result in step S106.

In step S108, for each division area, a mean value of L* values, a mean value of a* values and a mean value of b* values (mean value of the values calculated in step S104: mean L*a*b*) of the sub-division areas constituting the division area is calculated.

In step S109, for each division area, the mean L*a*b* calculated in step S108 is converted into the XYZ tristimulus value (mean XYZ tristimulus value). For example, the mean L*a*b* is converted into the mean XYZ tristimulus value by performing the operation in step S104 in reverse, for example.

The processings in steps S101 to S109 are executed for three cases: if display is based on image data of a single color R (red); if display is based on image data of a single color G (green); and if display is based on image data of a single color B (blue). In other words, the processings in steps S101 to S109 are executed for three cases: if red is displayed on the entire screen; if green is displayed on the entire screen; and if blue is displayed on the entire screen.

In step S110, a 3DLUT is created for each division area. For example, from the pre-correction pixel values, target values of the XYZ tristimulus values and the mean XYZ tristimulus values calculated in step S109, the pixel values to make the XYZ tristimulus values to be target values (post-correction pixel values) are calculated using Expressions 2-1 and 2-2, for example. Then the differences of the pre-correction pixel values and the post-correction pixel values are calculated as correction data corresponding to the pre-correction pixel values. In Expressions 2-1 and 2-2, R, G and B are the pre-correction pixel values (R value, G value and B value before correction). X, Y and Z are the target values of the XYZ tristimulus values (target value of X value, target value of Y value, target value of Z value). For example, the target values are XYZ tristimulus values calculated from the pre-correction pixel values. Xᵢ, Yᵢ and Zᵢ (i=R, G, B) are the average XYZ tristimulus values acquired by display based on the single color image data of i. R′, G′ and B′ are the post-correction pixel values (R value, G value and B value after correction). Using Expressions 2-1 and 2-2, a plurality of correction data corresponding to a plurality of pre-correction pixel values (a plurality of colors) is calculated for each division area. Then, for each division area, a 3DLUT to indicate correction data for each pre-correction pixel value is created from a plurality of correction data corresponding to a plurality of colors. In this embodiment, nine patterns (pattern numbers 1 to 9) of a 3DLUT are created.

$$\begin{matrix}[ E2 ] & \\ ( \begin{matrix}{R}_{tmp} \\ {G}_{tmp} \\ {B}_{tmp}\end{matrix} ) = {( \frac{1}{{Y}_{R} + {Y}_{G} + {Y}_{B}} ( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ) )}^{- 1} ( \begin{matrix}X \\ Y \\ Z\end{matrix} ) & ( Expression 2 \text{-} 1 ) \\ ( \begin{matrix}{R}^{′} \\ {G}^{′} \\ {B}^{′ }\end{matrix} ) = ( \begin{matrix}R \times {R}_{tmp} \\ G \times {G}_{tmp} \\ B \times {B}_{tmp}\end{matrix} ) & ( Expression 2 \text{-} 2 )\end{matrix}$$

The 3DLUTs and the 3DLUT assignment table created by the above mentioned method are stored in advance in a storage unit of the unevenness correction apparatus according to this embodiment.

In the case of FIG. 1, the 3DLUTs and the 3DLUT assignment table are created in parallel, but may be created sequentially.

The processings in steps S102 to S110 may be performed by a dedicated apparatus for generating a table, but may be performed by a dedicated apparatus for generating the tables, or by a standard personal computer executing an application program for generating the tables.

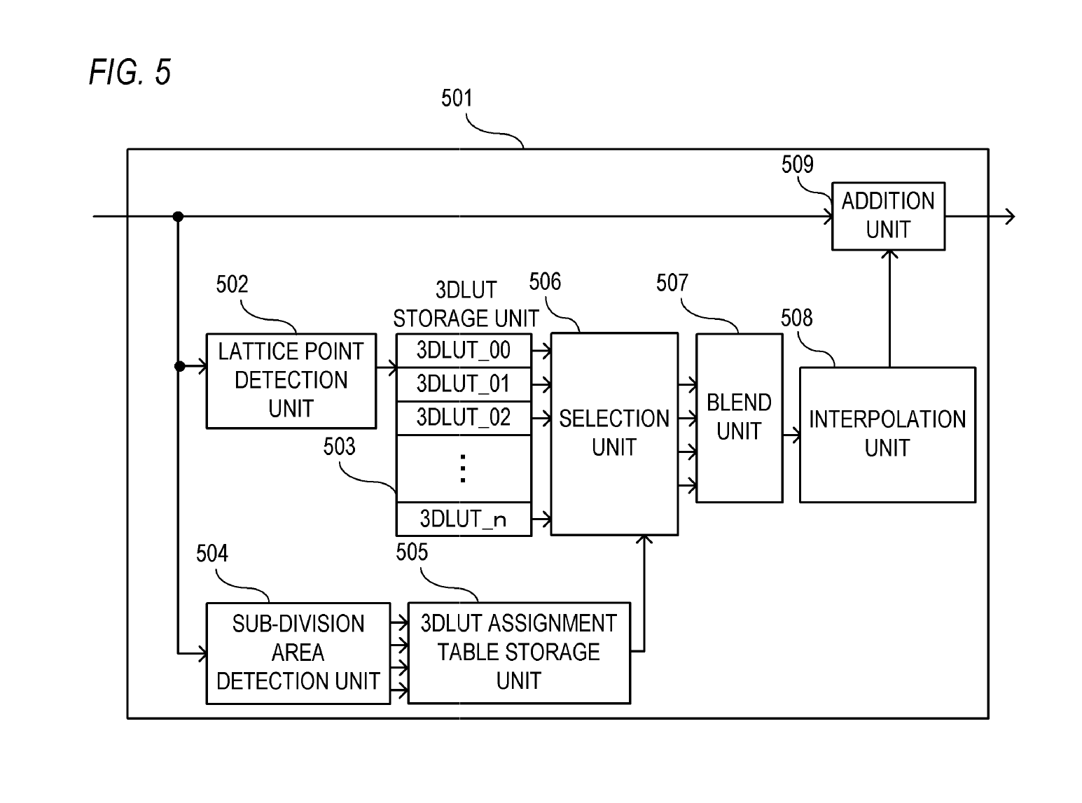

Now how to correct unevenness using a 3DLUT and the 3DLUT assignment table created by the above mentioned processing flow will be described. FIG. 5 is a block diagram depicting an example of a functional configuration of the unevenness correction apparatus 501 according to this embodiment. The unevenness correction apparatus 501 includes a lattice point detection unit 502, a 3DLUT storage unit 503, a sub-division area detection unit 504, a 3DLUT assignment table storage unit 505, a selection unit 506, a blend unit 507, an interpolation unit 508, and an addition unit 509.

An image data (RGB data) to be displayed on the display apparatus and synchronization signals thereof (e.g. vertical synchronization signal, horizontal synchronization signal, effective area signal) are input to the unevenness apparatus 501.

From the inputted RGB data, the lattice point detection unit 502 generates lattice point coordinates that indicate pixel values corresponding to correction data, which is read from the 3DLUT, for each pixel.

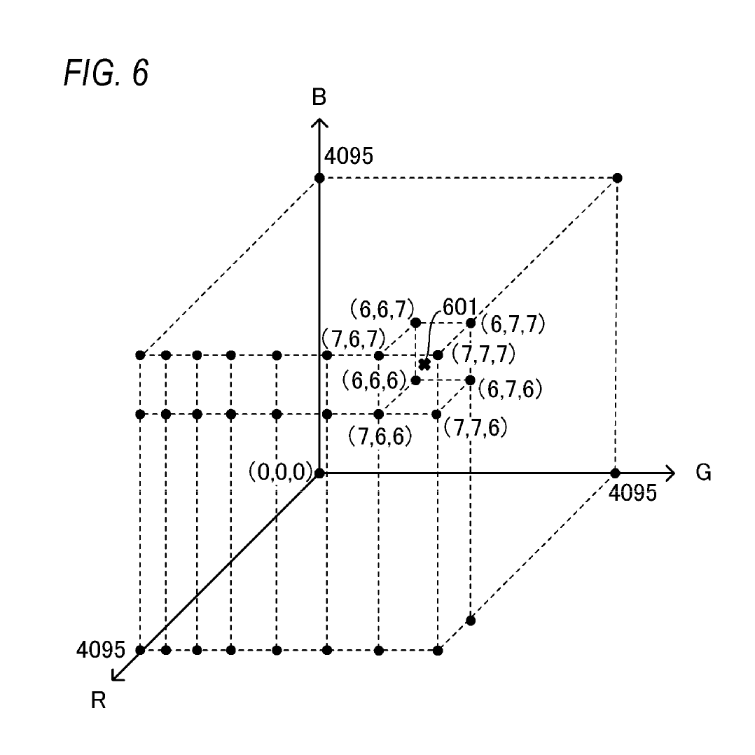

FIG. 6 shows an example of the lattice points of a 3DLUT (pixel values corresponding to the correction data of a 3DLUT). In the case of FIG. 6, a total of 512 lattice points exist: 8 points each for the R value, the G value and the B value. In other words, in the example of FIG. 6, one 3DLUT has 512 correction data corresponding to the 512 lattice points. The lattice points may be placed at equal intervals or at unequal intervals. The intervals of lattice points are preferably short in a gradation portion, where fine correction is required. FIG. 6 is an example when the generated unevenness requires fine correction for a low gradation portion. Therefore in FIG. 6, the intervals of the lattice points are set shorter in the low gradation portion that in the high gradation portion.

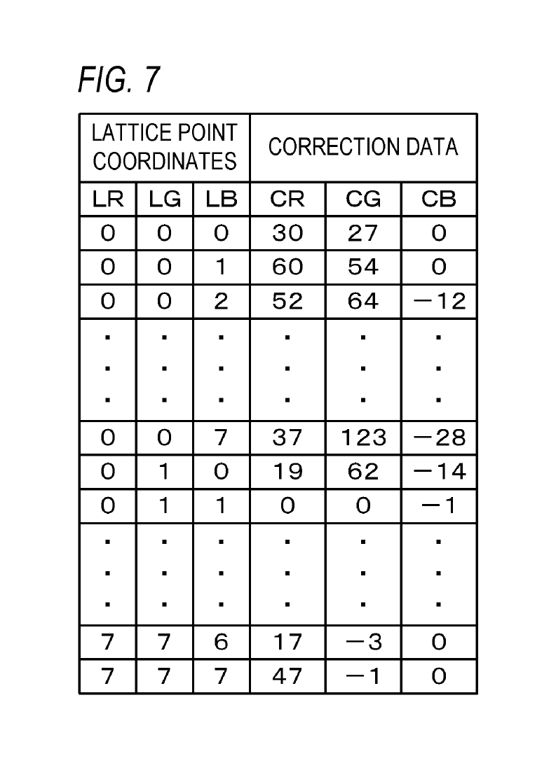

FIG. 7 shows an example of a 3DLUT. In FIG. 7, LR is a lattice point coordinate to indicate an R value of a lattice point, LG is a lattice point coordinate to indicate a G value of a lattice point, and LB is a lattice point coordinate to indicate a B value of a lattice point. The lattice point coordinates are numbered, so as to be 0 at a lattice point of which gradation value is the minimum, and incremented by 1 as gradation value increases. In FIG. 7, CR is correction data to correct the R value, CG is correction data to correct the G value, and CB is correction data to correct the B value.

The lattice point detection unit 502 outputs the coordinates of lattice points around a pixel value of the inputted RGB data to the 3DLUT storage unit 503. For example, if a pixel value of the inputted RGB data in a pixel value indicated by the reference numeral 601 in FIG. 6, the lattice point coordinates (LR, LG, LB)=(6, 6, 6), (6, 6, 7), (7, 6, 7), (7, 6, 6), (7, 7, 6), (6, 7, 6), (6, 7, 7) and (7, 7, 7) are outputted. The lattice coordinates to be outputted are not limited to these. For example, if a pixel value of the inputted RGB data matches with a pixel value of a lattice point, then only the coordinates of this lattice point may be outputted.

The 3DLUT storage unit 503 stores a 3DLUT for each division area. If a common 3DLUT is assigned to division areas, the one 3DLUT can be stored for these division areas. In this embodiment, nine 3DLUTs corresponding to the pattern numbers 1 to 9 in FIG. 4 are stored. Each 3DLUT is a table, as shown in FIG. 7. The 3DLUT storage unit 503 reads correction data of the lattice point coordinates, which were inputted from the lattice point detection unit 502, from each 3DLUT, and outputs the correction data to the selection unit 506. Therefore in this embodiment, 45 correction data (9 3DLUTs×8 lattice points=45) are outputted to the selection unit 506.

Based on the inputted synchronization signal and information that one sub-division area is constituted by 128 pixels×128 pixels, the sub-division area detection unit 504 detects a sub-division area where a target pixel (processing target pixel) is located, as a target area. The sub-division detection area 504 also detects sub-division areas near the target pixel, out of the sub-division areas adjacent to the detected sub-division area, as peripheral areas. Then the sub-division area detection unit 504 outputs the detection results of the target area and the peripheral areas to the 3DLUT assignment table storage unit 505.

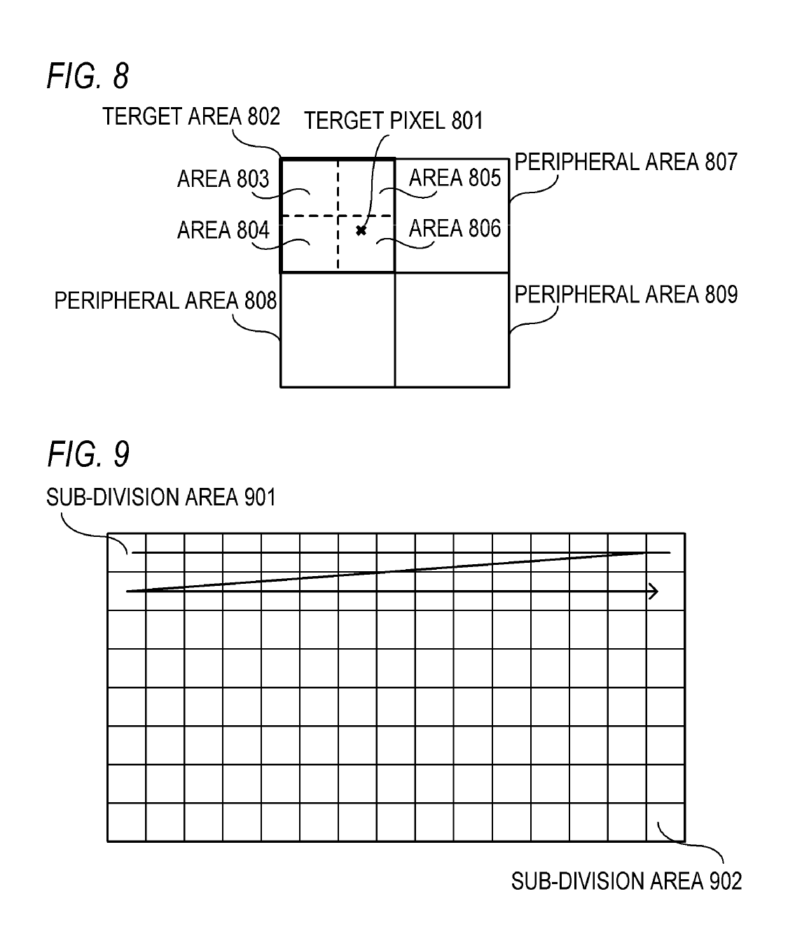

For example, it is assumed that a target pixel is a pixel 801 in FIG. 8. The sub-division area detection unit 504 first detects that the target pixel 801 is located in a sub-division area 802 (target area). Then the sub-division area detection unit 504 divides (equally divides) the target area 802 into two areas in the horizontal direction×two areas in the vertical direction=four areas (areas 803, 804, 805 and 806) as shown in FIG. 8. Then the sub-division area detection unit 504 detects which area, of areas 803, 804, 805 and 806, where the target pixel 801 is located. Then as peripheral areas, the sub-division area detection unit 504 detects the sub-division areas adjacent to the area where the target pixel is located. In the example in FIG. 8, the target pixel 801 is located in the lower right area 806, so the three sub-division areas 807, 808 and 809, which are at the right, bottom and lower right of, and adjacent to the target area 802, are detected as the peripheral areas. Then the sub-division area detection unit 504 outputs area numbers that indicate the detected target area and the peripheral areas to the 3DLUT assignment table storage unit 505. If the target area is located at the edge of the screen and no peripheral area is detected, the area number of the target area is outputted as the area number of the peripheral area. Thereby the latter mentioned addition unit 509 can perform the edge portion processing with setting the peripheral area as a target area. The area numbers are assigned in the sequence indicated by the arrow in FIG. 9, so as to increment by 1. In concrete terms, the area number of the sub-division area 901 (sub-division area at the upper left edge) is 0, and the area number increments by 1 in the right direction. After the area reaches the right edge, 1 is added to the area number of the sub-division area at the right edge, and this number becomes the area number of the sub-division area at the left edge in the second level. Then the area number of the sub-division area 902 (sub-division area at the lower right edge) becomes the last number.

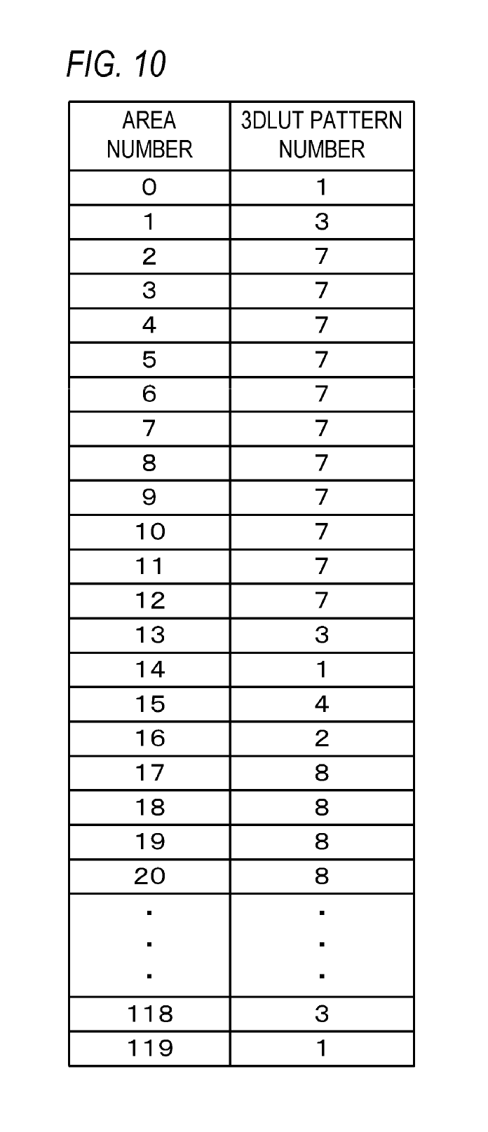

The 3DLUT assignment table storage unit 505 stores a 3DLUT assignment table that indicates a 3DLUT pattern number for each area number. FIG. 10 shows an example of the 3DLUT assignment table. In the case of FIG. 10, one of the pattern numbers 1 to 9 shown in FIG. 4 (a 3DLUT pattern number assigned in the processing flow in FIG. 1) corresponds to each of the 120 area numbers (0 to 119), which correspond to the 120 sub-division areas. The 3DLUT assignment table storage area 505 reads the pattern numbers corresponding to the area numbers inputted from the sub-division area detection unit 504 (area numbers of the target area and three peripheral areas) from the 3DLUT assignment table, and outputs the pattern numbers to the selection unit 506.

From the correction data inputted from the 3DLUT storage unit 503, the selection unit 506 selects correction data of the 3DLUTs corresponding to the pattern numbers inputted from the 3DLUT assignment table storage unit 505, and outputs the selected correction data to the blend unit 507. In this embodiment, four pattern numbers correspond to a total of four areas, that is the target area and three peripheral areas, are outputted, hence the output data of the selection unit 506 is 32 (=4 3DLUTs×8 lattice points) correction data.

The blend unit 507 blends the correction data of the target area and the correction data of the three peripheral areas. Then the blend unit 507 outputs the blend result to the interpolation unit 508. In concrete terms, for each lattice point number, four correction data (four correction data of which 3DLUTs are mutually different) of the lattice point number are blended. Therefore eight correction data are outputted from the blend unit 507 as the blend result.

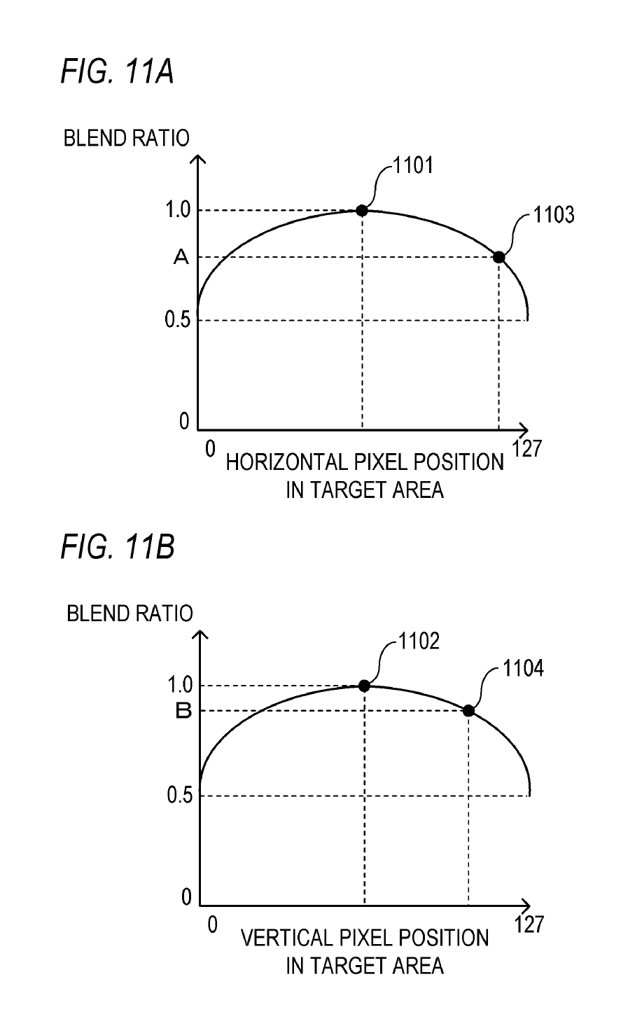

For example, the blend unit 507 performs blend processing using a blend ratio table for the horizontal direction and the vertical direction respectively. The blend ratio table is a table to indicate a blend ratio for each position of a target pixel in a target area, for example. FIG. 11A and FIG. 11B are graphs depicting a correspondence of a position of a target pixel and a blend ratio in the blend ratio table. In FIG. 11A, the abscissa indicates a horizontal position of the target pixel in the target area, and the ordinate indicates a blend ratio of the correction data of the target area. In FIG. 11B, the abscissa indicates a vertical position of the target pixel in the target area, and the ordinate indicates a blend ratio of the correction data of the target area.

If the horizontal position of the target pixel is a position corresponding to the point 1101, and the vertical position of the target pixel is a position corresponding to the point 1102, then the blend ratio in the horizontal direction and the blend ratio in the vertical direction are both 1.0 (100%). Therefore in such a case, the correction data of the target area is not blended with the correction data of the peripheral data, and the correction data of the target area is regarded as the blend result.

Now it is assumed that the horizontal position of the target pixel is a position corresponding to the point 1103, and the vertical position of the target pixel is a position corresponding to the point 1104. In other words, it is assumed that the target pixel is located in the lower right area, out of the four areas acquired by equally dividing the target area into four. In this case, regarding the weight of the correction data of the target area 802 as a blend ratio A that corresponds to the position 1104, and the weight of the correction data of the peripheral area 807 as 1−A, these correction data are blended. (The blend result is written as correction data C1.) Then regarding the weight of the correction data of the peripheral area 808 as a blend ratio A corresponding to the position 1104, and the weight of the correction data of the peripheral area 809 as 1−A, these correction data are blended. (The blend result is written as correction data C2.) Then regarding a weight of the correction data C1 as a blend ratio B corresponding to the position 1104 and the weight of the correction data C2 as 1−B, these correction data are blended. Thereby the correction data as the blend result is acquired. The method for the blend processing is not limited to this. For example, the blend processing in the horizontal direction may be performed after the blend processing in the vertical direction. Four correction data may be weighted and blended in one processing.

Blended eight correction data (eight correction data acquired by blending the correction data of the target area and three peripheral areas) are inputted to the interpolation unit 508. The interpolation unit 508 calculates (generates) the final correction data by linearly interpolating this correction data. The final correction data may be data acquired by linearly interpolating all the eight correction data, or may be data acquired by linearly interpolating a part of the eight correction data. For example, the final correction data may be data acquired by linearly interpolating correction data corresponding to four out of the eight lattice points on a plane that passes through the center of a cube constituted by the eight lattice points. The interpolation unit 508 outputs the calculated correction data (one final correction data) to the addition unit 509.

The addition unit 509 performs the unevenness correction processing on the RGB data (image data to be displayed on the display apparatus) inputted to the unevenness correction apparatus 501. According to this embodiment, the addition unit 509 adds the correction data inputted from the interpolation unit 508 to the RGB data inputted to the unevenness correction apparatus 501. In concrete terms, a correction value CR for the R value included in the correction data is added to the R value of the target pixel. In the same manner, the correction value CG is added to the G value, and the correction value CB is added to the B value. Then the addition unit 509 outputs the RGB data generated after the unevenness correction processing (after addition processing) to the outside (e.g. display apparatus).

In the above mentioned blend processing, the correction data is not changed by the blend processing if the target area and the peripheral area are areas in a same division area. In concrete terms, the correction data of the division area including the target pixel, becomes the result of the blending. If the target area and the peripheral areas are areas in mutually different division areas, then the correction data is changed by the blend processing. In concrete terms, the correction data of the division area including the target pixel, and the correction data of the division area adjacent to this division area are blended, and this blended correction data becomes the result of blending. The case when the target area and the peripheral area are areas in mutually different division areas is a case when the position of the target pixel is in the boundary portion between the division area including this position of the target pixel and another division area.

Therefore according to this embodiment, if the target position of the unevenness correction processing is in a boundary portion between a division area including this target position and another division area, the unevenness correction processing is performed using the correction table for the division area including this target position and the correction table for the other division area.

The method for the unevenness correction processing is not limited to this. The unevenness correction processing may be performed in any way for each position on the screen, only if at least one correction table, that includes the correction table for the division area including this position, is used, out of the correction tables stored for respective division areas. For example, the unevenness correction processing may be performed using only the correction table for the division area that includes the target position of the unevenness correction processing.

According to this embodiment, as described above, a relatively large division area is set in the center portion of the screen and a relatively small division area is set in each edge portion of the screen, as a division area for which one correction table is provided. Therefore the correction processing to correct unevenness on the screen can be accurately performed using a small amount of hardware resources. In concrete terms, the unevenness correction processing can be performed more accurately than the case when the sizes of a plurality of division areas are generally large. Further, the number of correction tables to be provided can be less than the case when the sizes of a plurality of division areas are generally small, hence less hardware resources are needed. Furthermore, unevenness is generated by the major changes of the color (color gamut) to be displayed and the brightness in the edge portions of the screen. In this embodiment, a size of a division area is small in the edge portions of the screen, therefore the unevenness can be finely (accurately) corrected.

This embodiment is an example when the sizes of the division areas in the four corner portions are smaller than the sizes of the division areas in the upper, lower, left and right edge portions (upper edge portion, lower edge portion, left edge portion and right edge portion), but the present invention is not limited to this. For example, the sizes of the division areas may be the same in the four corner positions and in the upper, lower, left and right portions. The edge portions need not be classified into four corner portions and into upper, lower, left and right portions.

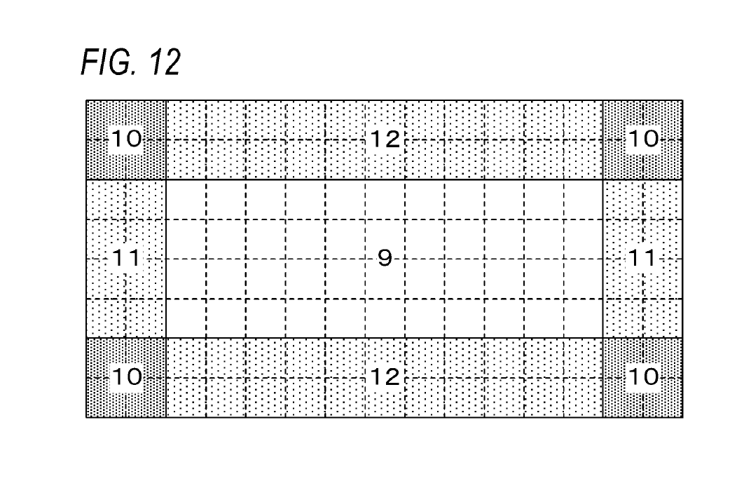

FIG. 12 shows a case when the number of 3DLUT patterns is four. Thus four patterns of 3DLUTs, of which pattern numbers are 9 to 12, may be used like this. As the number of 3DLUT patterns is less, a circuit scale can be smaller, and processing load can be decreased.

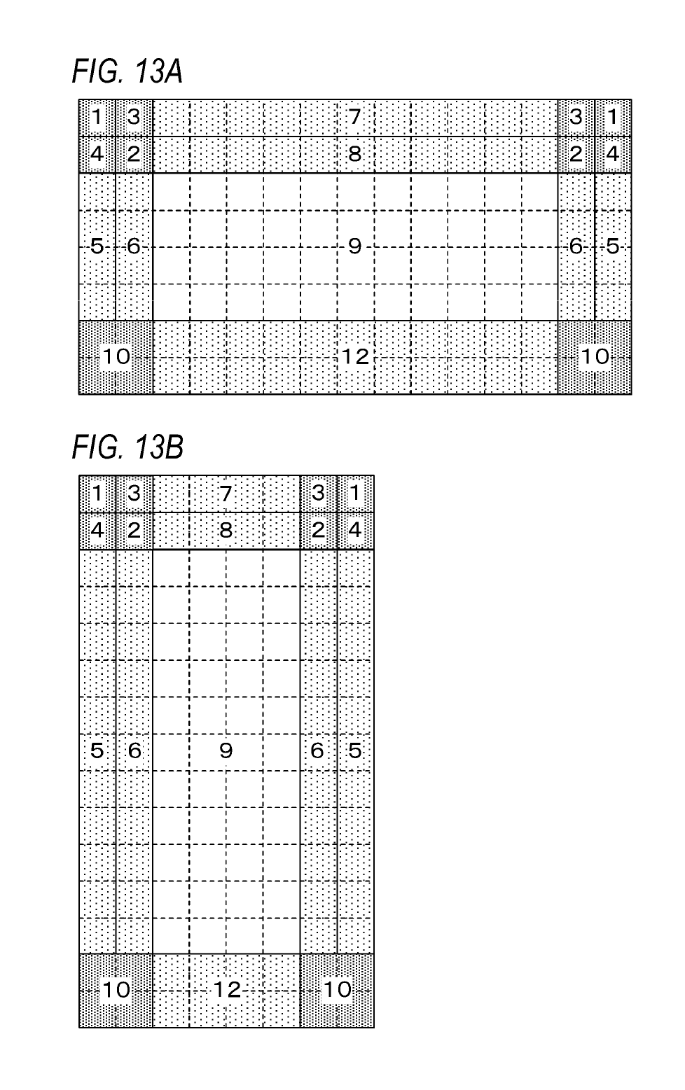

FIG. 13A and FIG. 13B showcases when the number of 3DLUT patterns is 11, considering the temperature distribution of the LED backlight. FIG. 13A shows an example of the correction table when the horizontal length of the screen of the display apparatus is longer than the vertical length thereof, and FIG. 13B shows an example of the correction table when the horizontal length of the screen of the display apparatus is shorter than the vertical length thereof. If the screen of the display apparatus can be rotated, one of the correction tables in FIG. 13A and FIG. 13B may be selected and used according to the rotation state of the screen of the display apparatus. In the case of FIG. 13A and FIG. 13B, the upper left corner portion and the upper right corner portion are divided into four division areas respectively, the upper, left and right edge portions (upper edge portion, left edge portion and right edge portion) are divided into two division areas respectively, and the lower left corner portion, the lower right corner portion and the lower edge portion are not divided. The aging deterioration of an LED backlight depends on the temperature distribution, and deterioration progresses faster in an area as the temperature of that area is higher. The temperature of the display apparatus has a tendency to become higher as the area of the screen is positioned higher. Therefore the 11 3DLUT patterns of which pattern numbers are 1 to 10 and 12, as shown in FIG. 13A and FIG. 13B, may be used considering the temperature distribution of the LED backlight.

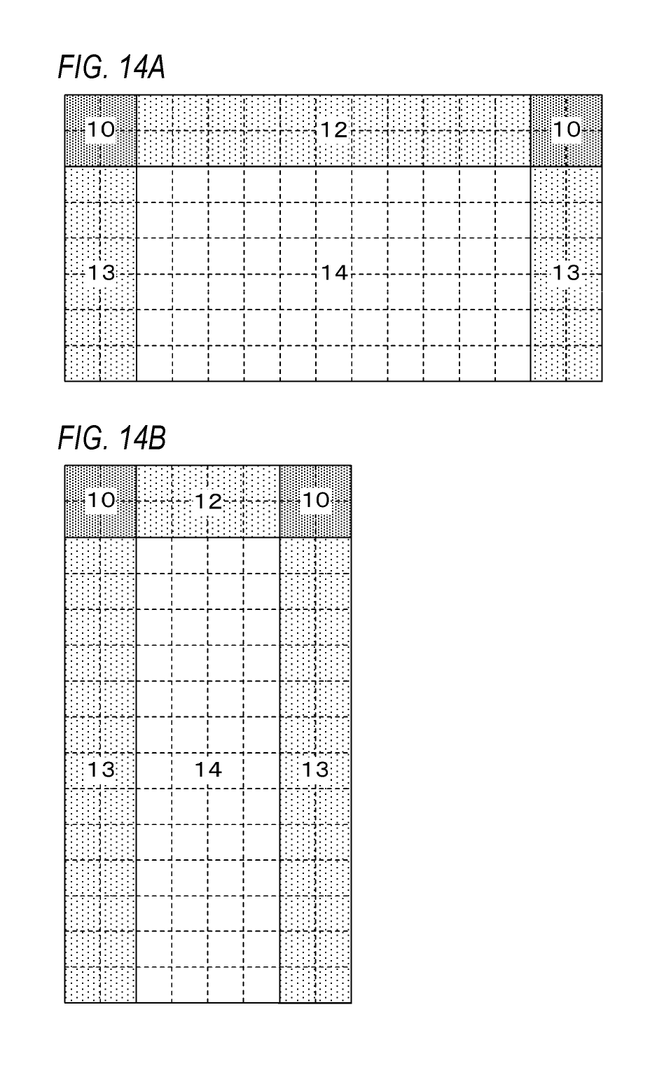

FIG. 14A and FIG. 14B showcases when the number of 3DLUT patterns is four, considering the temperature distribution of the LED backlight. FIG. 14A shows an example of the correction table when the horizontal length of the screen of the display apparatus is longer than the vertical length thereof, and FIG. 14B shows an example of the correction table when the horizontal length of the screen of the display apparatus is shorter than the vertical length thereof. If the screen of the display apparatus can be rotated, one of the correction tables in FIG. 14A and FIG. 14B may be selected and used according to the rotation state or the screen of the display apparatus. In the case of FIG. 14A and FIG. 14B, the sub-division areas are grouped into an upper left corner portion, an upper right corner portion, an upper edge portion, left and right edge portions and a center portion. As mentioned above, the temperature of the display apparatus has a tendency to become higher as the area of the screen is positioned higher. Therefore four 3DLUT patterns of which pattern numbers are 10 and 12 to 14, as shown in FIG. 14A and FIG. 14B, may be used considering the temperature distribution of the LED backlight.

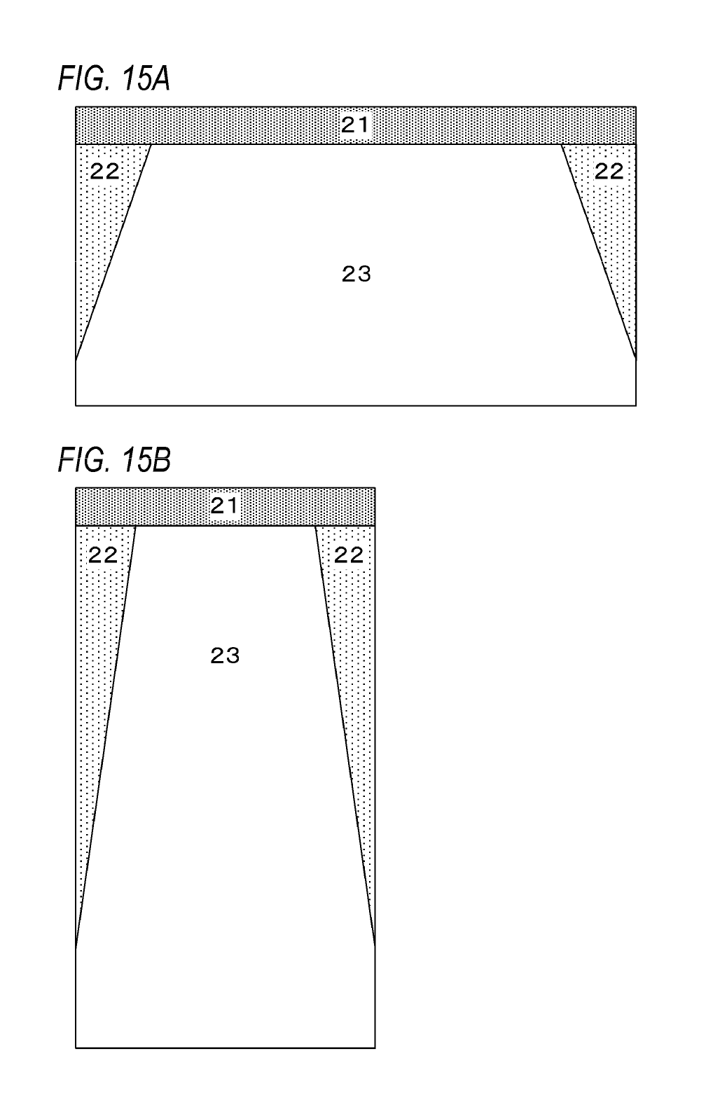

FIG. 15A and FIG. 15B showcases when the number of 3DLUT patterns is three, considering the temperature distribution of the LED backlight. FIG. 15A shows an example of the correction table when the horizontal length of the screen of the display apparatus is longer than the vertical length thereof, and FIG. 15B shows an example of the correction table when the horizontal length of the screen of the display apparatus is shorter than the vertical length thereof. If the screen of the display apparatus can be rotated, one of the correction tables in FIG. 15A and FIG. 15B may be selected and used according to the rotation state of the screen of the display apparatus. In the case of FIG. 15A and FIG. 15B, the sub-division areas are grouped into an upper edge portion, left and right edge portions, and a center portion. As mentioned above, the temperature of the display apparatus has a tendency to get higher as the area is the screen is positioned higher. Therefore three 3DLUT patterns of which pattern numbers are 21 to 23, as shown in FIG. 15A and FIG. 15B, may be used considering the temperature distribution of the LED backlight.

The left and right edge portions may have triangular shapes as shown in FIG. 15A and FIG. 15B, or may have square shapes as shown in FIG. 14A and FIG. 14B.

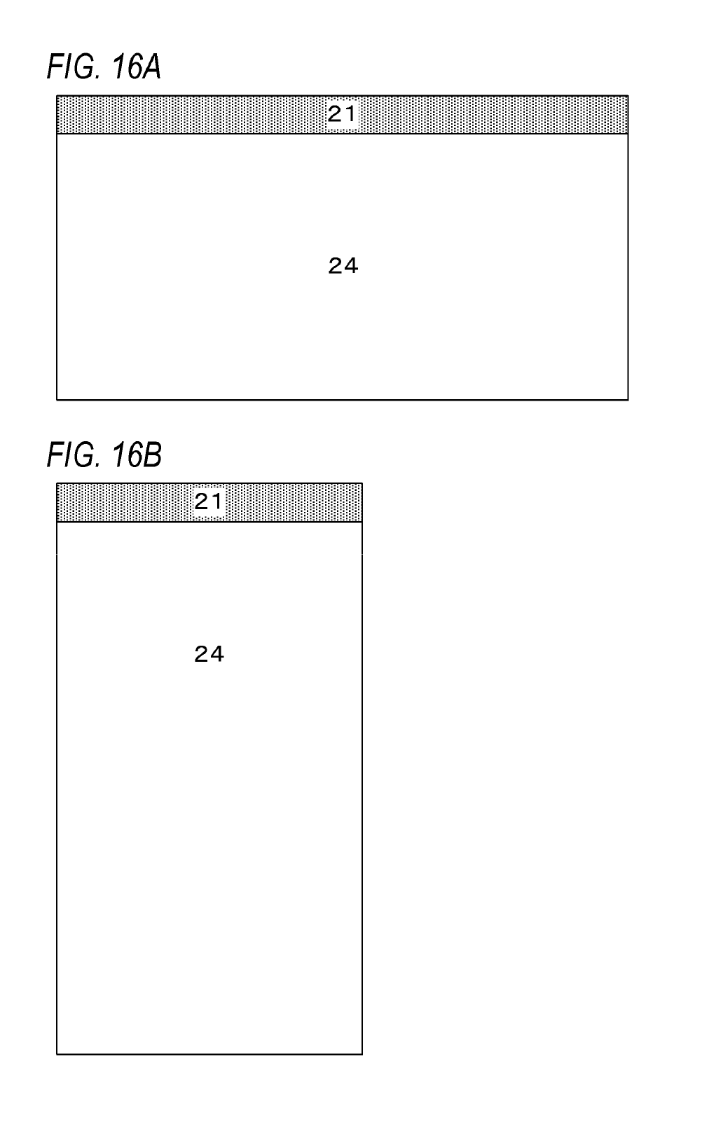

FIG. 16A and FIG. 16B show cases when the number of 3DLUT patterns is two, considering the temperature distribution of the LED backlight. FIG. 16A shows an example of the correction table when the horizontal length of the screen of the display apparatus is longer than the vertical length thereof, and FIG. 16B shows an example of the correction table when the horizontal length of the screen of the display apparatus is shorter than the vertical length thereof. If the screen of the display apparatus can be rotated, one of the correction tables in FIG. 16A and FIG. 16B may be selected and used according to the rotation state of the screen of the display apparatus. In the case of FIG. 16A and FIG. 16B, the sub-division areas are grouped into an upper edge portion and a center portion (portion other than the upper edge portion). As mentioned above, the temperature of the display apparatus has a tendency to get higher as the area of the screen is positioned higher. Therefore two 3DLUT patterns of which pattern numbers are 21 and 24, as shown in FIG. 16A and FIG. 16B, may be used considering the temperature distribution of the LED backlight.

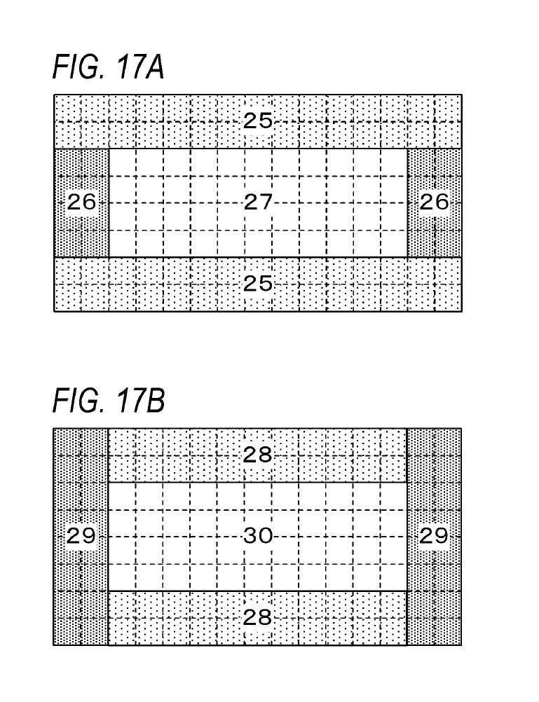

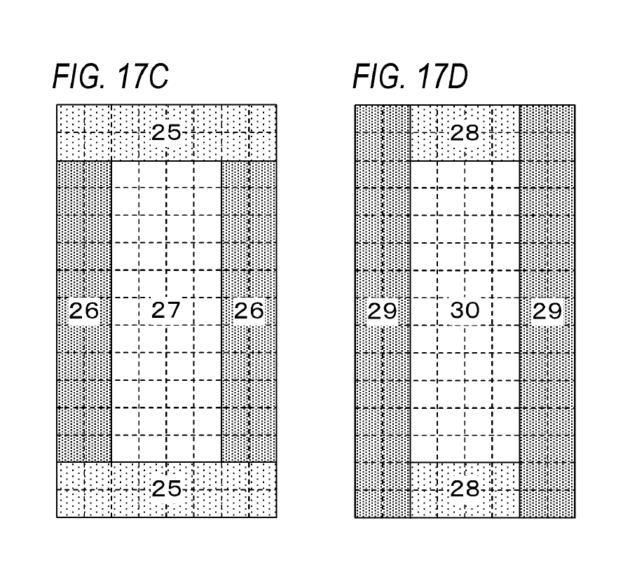

FIG. 17A to FIG. 17D show cases when the number of 3DLUT patterns is three. FIG. 17A and FIG. 17B show examples of the correction table when the horizontal length of the screen of the display apparatus is longer than the vertical length thereof, and FIG. 17C and FIG. 17D show examples of the correction table when the horizontal length of the screen of the display apparatus is shorter than the vertical length thereof. If the screen of the display apparatus can be rotated, one of the correction tables in FIG. 17A and FIG. 17C may be selected and used according to the rotation state of the screen of the display apparatus. Also one of the correction tables in FIG. 17B and FIG. 17D may be selected and used according to the rotation state of the screen of the display apparatus. In the case of FIG. 17A to FIG. 17D, the sub-division areas are grouped into upper, lower left and right edge portions and a center portion (portion other than upper edge portion). Three 3DLUT patterns of which pattern numbers are 25 to 27, as shown in FIG. 17A and FIG. 17C, or three 3DLUT patterns of which pattern numbers are 28 to 30, as shown in FIG. 17B and FIG. 17D, may be used.

### Embodiment 2

In Embodiment 2, examples which are particularly suitable for a liquid crystal display apparatus having an edge light type backlight (light sources, such as LEDs, are disposed at the edges of the screen, so that surface light is irradiated using a light guiding plate) will be described.

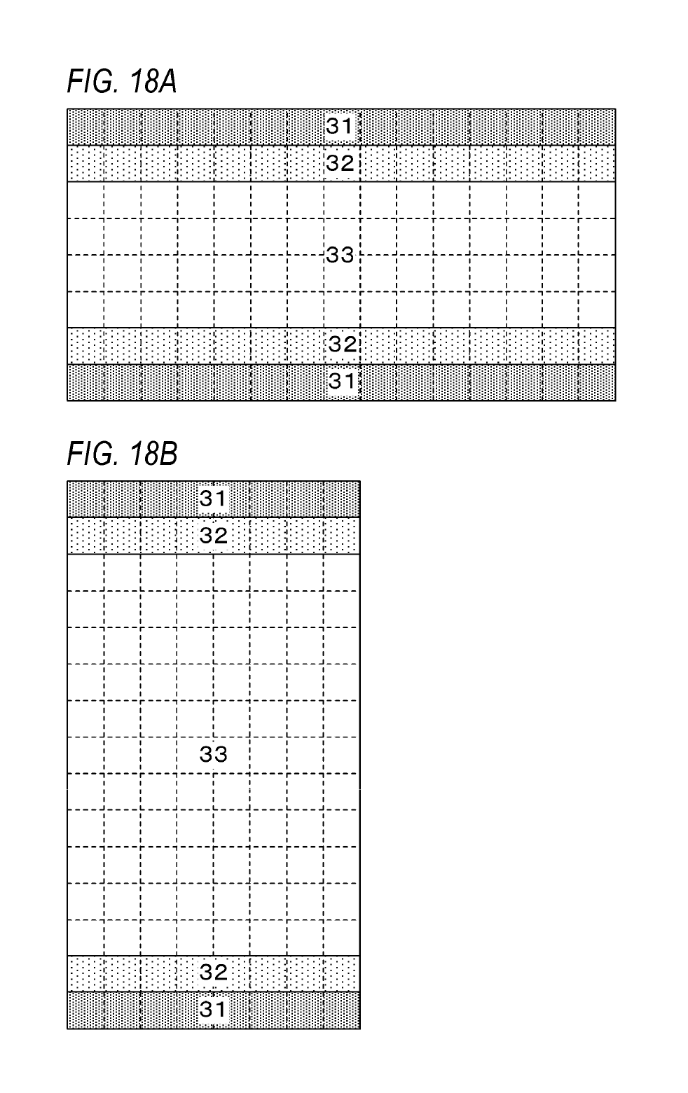

FIG. 18A and FIG. 18B show examples of correction tables which are suitable for a liquid crystal display apparatus having an edge light type backlight where light sources are disposed in the upper and lower edges of the screen. FIG. 18A shows an example of a correction table when the horizontal length of the screen of the display apparatus is longer than the vertical length thereof, and FIG. 18B shows an example of the correction table when the horizontal length of the screen of the display apparatus is shorter than the vertical length thereof. If the screen of the display apparatus can be rotated, one of the correction tables in FIG. 18A and FIG. 18B may be selected and used according to the rotation state of the screen of the display apparatus. In the case of FIG. 18A and FIG. 18B, the upper and lower edge portions (upper edge portion and lower edge portion) are divided into two division areas respectively. In the case of the edge light type backlight, light from the light sources is diffused by the light guiding plate, and spreads over the surface, and unevenness tends to generate near the light sources at the upper and lower edges, which receive the influence of light more easily. Therefore the upper edge portion and the lower edge portion are divided into two division areas respectively, and the center portion is not divided. In this way, three 3DLUT patterns, of which pattern numbers are 31 to 33, as shown in FIG. 18A and FIG. 18B, may be used considering the arrangement of the light sources.

The correction tables in FIG. 18A and FIG. 18B are also suitable for a liquid crystal display apparatus having an edge light type backlight, of which light sources are only in the upper edge or only in the lower edge of the screen. For example, if the light sources are disposed only in the upper edge of the screen, unevenness tends to generate in an area near the light sources in the upper edge, which receives the influence of light more easily. In the lower edge area, on the other hand, where diffused light cannot sufficiently reach and the influence of the edges of the panel is also received, unevenness tends to generate as well. Therefore it is preferable to use three 3DLUT patterns of which pattern numbers are 31 to 33, as shown in FIG. 18A and FIG. 18B.

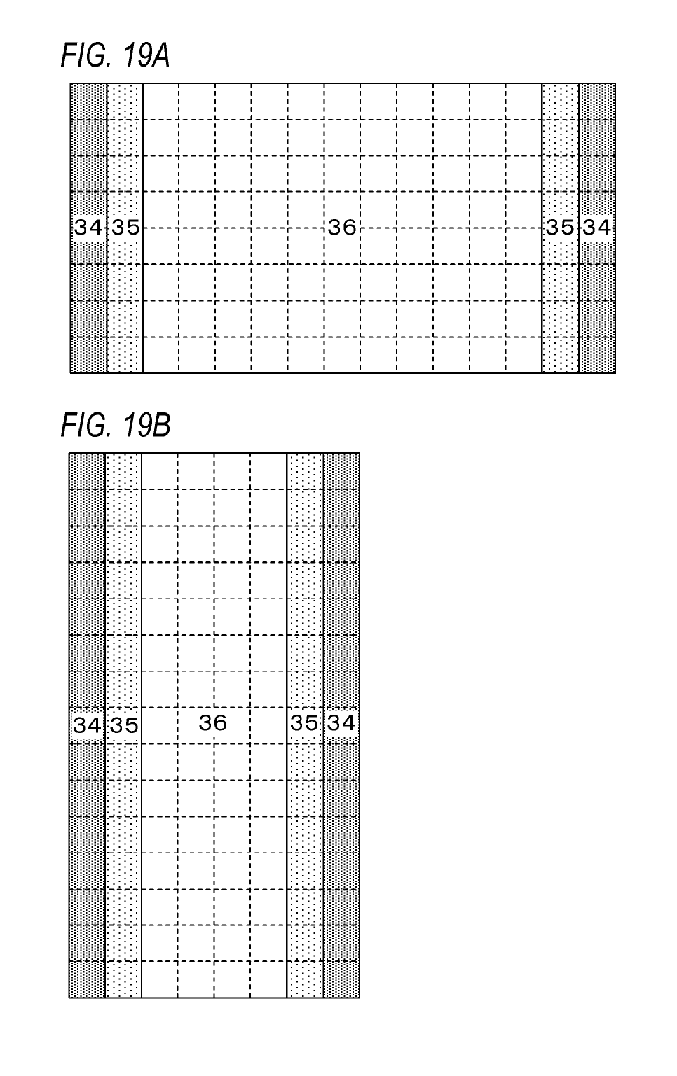

FIG. 19A and FIG. 19B show examples of correction tables which are suitable for a liquid crystal display apparatus having an edge light type backlight, where light sources are disposed in the left and right edges of the screen. FIG. 19A shows an example of a correction table when the horizontal length of the screen of the display apparatus is longer than the vertical length thereof, and FIG. 19B shows an example of the correction table when the horizontal length of the screen of the display apparatus is shorter than the vertical length thereof. If the screen of the display apparatus can be rotated, one of the correction tables in FIG. 19A and FIG. 19B may be selected and used according to the rotation state of the screen of the display apparatus. In the case of FIG. 19A and FIG. 19B, the left and right edge portions (left edge portion and right edge portion) are divided into two division areas respectively. In the case of the edge light type backlight, light from the light sources is diffused by the light guiding plate and spreads over the surface, and unevenness tends to generate near the light sources at the left and right edges which receive the influence of the light more easily. Therefore the left edge portion and the right edge portion are divided into two division areas respectively, and the center portion is not divided. In this way, three 3DLUT patterns of which pattern numbers are 34 to 36, as shown in FIG. 19A and FIG. 19B, may be used considering the arrangement of the light sources.

The correction tables in FIG. 19A and FIG. 19B are also suitable for a liquid crystal display apparatus having an edge light type backlight of which light sources are only in the left edge, or only in the right edge of the screen. For example, if the light sources are disposed only in the left edge of the screen, unevenness tends to generate in an area near the light source in the left edge, which receives influence of light more easily. In the right edge area, on the other hand, where diffused light cannot reach sufficiently and influence of the edges of the panel is also received, unevenness tends to generate as well. Therefore it is preferable to use three 3DLUT patterns of which pattern numbers are 34 to 36, as shown in FIG. 19A and FIG. 19B.

In each of the above described embodiments, a value to be added to the pixel values is provided as correction data, but the correction data is not limited to this. For example, the correction data may be a value by which the pixel value is multiplied, or may be a coefficient used for a predetermined correction function.

In each of the above described embodiments, two types of areas, that is a division area and a sub-division area, are set, but the sub-division areas need not be set. Blending of the correction data may be controlled not by a position of the target pixel in a sub-division area, but by a position of a target pixel in a division area.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-087377, filed on Apr. 6, 2012, and Japanese Patent Application No. 2013-031096, filed on Feb. 20, 2013, which are hereby incorporated by reference herein in their entirety.

What is claimed is:

1. An unevenness correction apparatus comprising:
a storage unit that stores correction tables, which are used for correction processing to correct unevenness on a screen of a display apparatus, for a plurality of division areas constituting an area of the screen respectively; and
a correction unit that performs the correction processing on image data to be displayed on the display apparatus, using at least one correction table which includes a correction table for a division area including a target position of the correction processing, out of the correction tables for respective division areas stored in the storage unit, wherein
a relatively large division area is set in a center portion of the screen, and a relatively small division area is set in an edge portion of the screen.

2. The unevenness correction apparatus according to claim 1, wherein
the edge portion includes an upper edge portion of the screen.

3. The unevenness correction apparatus according to claim 2, wherein
the edge portion further includes a lower edge portion of the screen.

4. The unevenness correction apparatus according to claim 3, wherein
a division area smaller than the lower edge portion is set for the upper edge portion.

5. The unevenness correction apparatus according to claim 1, wherein
the edge portion includes a left edge portion and a right edge portion of the screen.

6. The unevenness correction apparatus according to claim 1, wherein
the edge portion includes corner portions of the screen.

7. The unevenness correction apparatus according to claim 6, wherein
a division area smaller than the edge portion other than the corner portions is set in the corner portions.

8. The unevenness correction apparatus according to claim 1, wherein
the division area is an area acquired by dividing the area of the screen based on the unevenness on the screen, which is generated when one color image data is displayed on the display apparatus.

9. The unevenness correction apparatus according to claim 1, wherein
when the target position of the correction processing is in a boundary portion between a division area including the target position and another division area, the correction unit performs the correction processing using a correction table for the division area including the target position and a correction table for the other division area.

10. A method for controlling an unevenness correction apparatus that has a storage unit which stores, in advance, correction tables to be used for correction processing to correct unevenness on the screen, for a plurality of division areas constituting an area of a screen of a display apparatus respectively, the method comprising:
a step of inputting image data which is displayed on the display apparatus; and
a correction step of performing the correction processing on the image data, using at least one correction table which includes a correction table for a division area including a target position of the correction processing, out of the correction tables for respective division areas stored in the storage unit, wherein
a relatively large division area is set in a center portion of the screen, and a relatively small division area is set in an edge portion of the screen.

11. The method for controlling an unevenness correction apparatus according to claim 10, wherein
the edge portion includes an upper edge portion of the screen.

12. The method for controlling an unevenness correction apparatus according to claim 11, wherein
the edge portion further includes a lower edge portion of the screen.

13. The method for controlling an unevenness correction apparatus according to claim 12, wherein
a division area smaller than the lower edge portion is set for the upper edge portion.

14. The method for controlling an unevenness correction apparatus according to claim 10, wherein
the edge portion includes a left edge portion and a right edge portion of the screen.

15. The method for controlling an unevenness correction apparatus according to claim 10, wherein
the edge portion includes corner portions of the screen.

16. The method for controlling an unevenness correction apparatus according to claim 15, wherein
a division area smaller than the edge portion other than the corner portions is set in the corner portions.

17. The method for controlling an unevenness correction apparatus according to claim 10, wherein
the division area is an area acquired by dividing the area of the screen based on the unevenness on the screen, which is generated when one color image data is displayed on the display apparatus.

18. The method for controlling an unevenness correction apparatus according to claim 10, wherein
in the correction step, when the target position of the correction processing is in a boundary portion between a division area including the target position and another division area, the correction processing is performed using a correction table for the division area including the target position and a correction table for the other division area.
